(19) United States
(12) Patent Application Publication
(10) Pub. No.: US 2006/0023694 A1
(43) Pub. Date: Feb. 2, 2006

(54) Financial transaction processing via combined voice/data financial transaction communications device and call control and service logic system

(76) Inventors: Paul Wilson, Suwanee, GA (US); Barry Danz, Alpharetta, GA (US)

Correspondence Address: Bambi F. Walters, P.O. Box 5743, Williamsburg, VA, 23188, US

(21) Appl. No.: 10/903,117

(22) Filed: Jul. 30, 2004

(51) Int. Cl. H04L 12/66

(52) U.S. Cl. 370/352

(57) ABSTRACT

A voice/data financial transaction communications device communicates with a call control and service logic system to process financial transactions. The device includes an integrated credit card processing terminal and a computer program product that detects and decodes financial data, associates the financial data with other transactional data, creates a financial transaction request, and communicates the request to an authorization communications address via the call control and service logic system and a data communications network and/or a telecommunications network. In response to the request, a message is communicated and presented to the device with payment authorization (or alternate message) to complete the financial transaction.

### CROSS REFERENCE TO RELATED APPLICATIONS

This application relates to applicants' co-pending application entitled “Voice/Data Financial Transaction Communications Device” (BS030578/04-BS010) filed simultaneously herewith and of which the “Brief Summary of the Invention” and “Detailed Description of the Invention” sections are incorporated herein by this reference.

This application relates to applicants' co-pending application entitled “Voice/Data Financial Transaction Monitoring Methods and Systems,” (BS040091/04-BS016) filed simultaneously herewith and of which the “Brief Summary of the Invention” and “Detailed Description of the Invention” sections are incorporated herein by this reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND OF THE INVENTION

1. Field of the Invention

This invention generally relates to Internet telephony, and, more particularly relates to systems and methods of processing a financial transaction from a Voice-Over Internet Protocol communications device over a data communications network and/or a telecommunications network.

2. Description of Related Art

Internet Telephony also referred to herein as Voice-Over Internet Protocol (VoIP), Voice-Over Network (VoN), and/or Internet Protocol Telephony (IP Telephony), is experiencing explosive growth and marked improvements in reliability and sound quality. The improved Internet Telephony communications are, in large part, due to upgrading the internet backbone with better switching fabrics, such as Asynchronous Transfer Mode (ATM), and also due to implementation of new communications standards, such as standards for transport protocols, directory services, and/or audio codec format.

These improvements and growth of IP telephony are influencing traditional telecommunications networks. The Public Switched Telephone Network (PSTN) is integrating with data networks, such as the Internet Protocol (IP) Network. Conventional voice technology (e.g., a Plain Old Telephone (POTS) call) processes the analog communications signal over a circuit-switched telecommunications network, however with advances in IP telephony, voice technology is reaching towards a packet-switched data network. Rather than risking just “jumping” over to the IP-based communications network that still faces many engineering and distribution challenges, communications providers (e.g., telecommunications service providers, internet service providers, and so on) use a hybrid network that relies on proven performance and a large distribution of the Public Switched Telephone Network (PSTN) with the IP-based network to leverage the assets of both networks.

Along with these improvements come new challenges for the industry. For example, a need exists for better, more efficient and secure financial transactions from an Internet telephony communications device. Today, most merchants process financial transactions with an ATM/debit/credit card processing service to receive payment from a customer. Equipment for the ATM/debit/credit card processing service typically includes a terminal, an analog phone, and a router. When the customer makes a purchase (e.g., buys groceries, gas, and so on) and uses a credit, debit, or ATM card (hereinafter referred to as a “credit card”), the customer typically swipes, inserts, and/or otherwise presents a magnetic reader of his/her card to a credit card processing terminal at the point of sale (POS). The credit card terminal device reads the magnetic reader, dials an associated card authorization number, routes and communicates a payment request to the credit card authorization center via the PSTN, and then communicates a response to the request (e.g., approval or denial) from the credit card authorization center to the terminal. This authorization process sometimes encounters a variety of problems including errors reading the credit card, hardware and equipment malfunctions, and communications problems. For example, if a router that connects multiple terminals at check out counters (POS) in a grocery store malfunctions, then no credit card transactions can be processed from any of the terminals until the router is fixed. Consequently, the grocery store may lose money when customers become frustrated or do not have another payment alternative. Additionally, credit card processing equipment today tends to be somewhat large and bulky, taking up counter space that could be used to promote merchandise, and consequently lead to other financial losses.

Accordingly, systems and methods are needed for a credit card authorization process from a VoIP communications device over data networks and/or telecommunications networks. Additionally, methods and systems that provide increased efficiency are further needed for these VoIP credit card related financial transactions.

### SUMMARY OF THE INVENTION

This invention addresses the above needs and other needs by providing systems, methods, computer programs, and/or computer program products to process and/or communicate a financial transaction request from a voice/data financial transaction communications system. This invention, in particular, provides a VoIP phone equipped with a credit card processing terminal and a VoIP financial transaction communications computer software product in communication with a call control and service logic system. The VoIP financial transaction communications computer software product (also referred to herein as the “VoIP Financial Transaction Module”) receives data of a financial card medium (e.g., Visa, MasterCard, debit cards, gift cards, store credit, and so on) from a card reader subsystem in its credit card processing terminal, then analyzes and associates the card medium financial data with transactional data. Thereafter, a financial transaction request is communicated via a call control and service logic system to a communications network for processing and communications with a financial institution. In response to the request, an authorization (or an alternate message) is communicated from a financial institution authorization communications address via the communications network and the call control and service logic system to the VoIP phone. According to further embodiments, the VoIP phone may print a receipt documenting the financial transaction. Because the voice/data financial transaction communications system leverages communications assets of the VoIP phone, call control and service logic system, and communications network, the VoIP phone may simultaneously process the financial transaction and also provide a voice communications connection so that a merchant and/or another user may use the VoIP phone to place or to receive a telephone call while the financial transaction is in progress.

According to embodiments of this invention, a voice/data financial transactions communications system includes a VoIP communications device equipped with a card reader subsystem, a VoIP Financial Transactions Module stored in memory, a processor communicating with the memory device, and a communications interface to a call control and service logic system for communicating with a communications network. The VoIP Financial Transaction Module includes a computer program product that accesses and associates financial data from a financial card medium with transactional data to prepare a financial transaction request. The financial card medium data includes a financial institution authorization communications address, a card identifier, an expiration date, a monetary limit for a financial transaction, and a card holder identifier. The transactional data includes data identifying a merchant, such as, for example, a merchant communications address, a merchant identifier, and/or a financial institution of the merchant, data identifying a good and/or service of the financial transaction, and data identifying a monetary amount of the financial transaction. The VoIP Financial Transactions Module communicates the financial transaction request to the call control and service logic system via the communications interface, and thereafter the request is routed and/or further communicated from the call control and service logic system to the financial institution authorization communications address via a communications network, such as, for example, a telecommunications network (e.g., Public Switched Telephone Network (PSTN)), a data communications network (e.g., an Internet Protocol communications network), and/or a satellite network. The financial transaction request includes the financial card medium data and transactional data including the monetary amount for the financial transaction. In response to the request, a financial institution of the financial institutional authorization communications address processes the request and communicates an authorization message with approval (or, alternatively, denial or another message) of the financial transaction request to the voice/data financial transaction communications system. The VoIP Financial Transaction Module receives and processes the authorization message to complete the financial transaction. In further embodiments, the voice/data financial transaction communications system includes a printer, and the VoIP Financial Transaction Module may instruct the printer to print out a receipt or other documentation of the financial transaction.

According to other embodiments of this invention, a computer program product includes a computer readable medium and a VoIP Financial Transaction Module stored on the computer readable medium. Similar to the above embodiment, the VoIP Financial Transaction Module detects and receives data from a financial card medium of a card reader subsystem of a VoIP phone and associates the financial card medium data with transactional data to create a financial transaction request. The VoIP Financial Transaction Module communicates the financial transaction request to a financial institution authorization communications address via the call control and service logic system and communications network, and, in response to the request, receives an authorization (or alternate message) from the financial institution authorization communications address.

According to other embodiments of this invention, a method of processing financial transactions includes receiving data of a financial card medium from a card reader subsystem of a VoIP communications device, analyzing and associating the financial card medium data with other transactional data, preparing a financial transaction request, communicating the request to a financial institution authorization communications address via a call control and service logic system and a communications network, and, in response to the request, receiving an authorization (or alternate message) from the financial institution authorization communications address again via the call control and service logic system. Further embodiments, include printing a receipt or other alternate documentation of the financial transaction, such as an email or text message confirmation.

Other systems, methods, and/or computer program products according to embodiments will be or become apparent to one with skill in the art upon review of the following drawings and detailed description. It is intended that all such additional systems, methods, and/or computer program products be included within this description, be within the scope of this invention, and be protected by the accompanying claims.

### BRIEF DESCRIPTION OF THE DRAWINGS

The above and other embodiments, objects, uses, advantages, and novel features of this invention are more clearly understood by reference to the following description taken in connection with the accompanying figures, wherein:

FIG. 1 illustrates a block diagram of an operating system according to exemplary embodiments of this invention;

FIG. 2 illustrates an operating environment for processing financial transactions according to exemplary embodiments of this invention;

FIG. 3 illustrates another operating environment for processing financial transactions according to exemplary embodiments of this invention;

FIG. 4 illustrates another example of an operating environment for processing financial transactions according to exemplary embodiments of this invention;

FIG. 5 illustrates still another operating environment for processing financial transactions according to exemplary embodiments of this invention;

FIG. 6 illustrates a block diagram of an alternative operating system according to exemplary embodiments of this invention; and

FIG. 7 illustrates a flowchart of a method for processing financial transactions according to exemplary embodiments of this invention.

### DETAILED DESCRIPTION OF THE DRAWINGS

This invention now will be described more fully hereinafter with reference to the accompanying drawings, in which exemplary embodiments are shown. This invention may, however, be embodied in many forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, flowcharts, illustrations, and the like represent conceptual views or processes illustrating systems, methods, and computer program products embodying this invention. The functions of the various elements shown in the figures may be provided through the use of dedicated hardware, as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

This invention provides systems, methods, and computer program products for processing and/or otherwise communicating a financial transaction between a voice/data financial transaction communications system and a financial institution authorization communications address. The voice/data financial transaction communications system includes a Voice over Internet Protocol (VoIP) phone having an integrated credit card processing terminal and a VoIP Financial Transaction Module. The VoIP Financial Transaction Module detects and decodes financial data from the credit card processing terminal (e.g., a credit card magnetic strip (also referred to herein as “magstripe”) is swiped or otherwise obtained via a card reader subsystem). The VoIP Financial Transaction Module then associates the financial data with other transactional data to create a financial transaction request. As used herein, the term “financial data” includes data of a financial institution authorization communications address, a card identifier, an expiration date, a monetary limit for a financial transaction, and/or a cardholder identifier (e.g., the cardholder name). As used herein, the term “transactional data” includes data identifying a merchant, such as a merchant communications address, a merchant identifier, and/or a financial institution of the merchant, data identifying a good and/or service of the financial transaction, and data identifying a monetary amount of the financial transaction. The VoIP Financial Transaction Module communicates the request to the communications network via the call control and service logic system. An example of a call control and service logic system is Bellsouth™ Centrex IP. However another exemplary call control and service logic system may be an outsourcing solution such as a long distance IP telephony carrier or an Internet Protocol service provider. Thereafter, the communications network processes and connects the request to the financial institution authorization communications address. In response to the request, the VoIP Financial Transactions Module receives an authorization message (e.g., approval, denial, and/or an alternate message about the transaction) via the call control and service logic system and completes the financial transaction. In some embodiments, the VoIP Financial Transaction Module may instruct a printer to print a receipt or other documentation of the financial transaction. The voice/data financial transaction communications system provides a creative, integrated communications solution that incorporates credit card processing equipment with the communications assets of Internet telephony communications devices and systems. An advantage of the voice/data financial transaction communications system is allowing the VoIP phone to simultaneously communicate with the financial institution (e.g., the request and authorization) and with another party or communications device. For example, if a merchant has an incoming call to the VoIP phone during the financial transaction, then merchant may answer the call and have a conversation at the same time as the financial processing (without disabling the financial transaction communications). And, similarly, if the merchant has an incoming electronic data message (e.g., an email), then the merchant may view, read, and/or listen to the electronic data message at the same time as the processing of the financial transaction. Thus, the voice/data financial transactions communications system streamlines communications and financial transaction processing. Another advantage is using the VoIP Financial Transaction Module to create the request using financial data of the card medium and transactional data, to control communications connections, and to manage financial transaction communications including the request and/or the authorization. For example, the VoIP Financial Transaction Module may communicate with other systems and applications to provide up-to-date merchant data, to provide another means of tracking goods and/or services, and/or to determine alternate communications connections with the authorization financial institution communications address (e.g., when a server is unavailable).

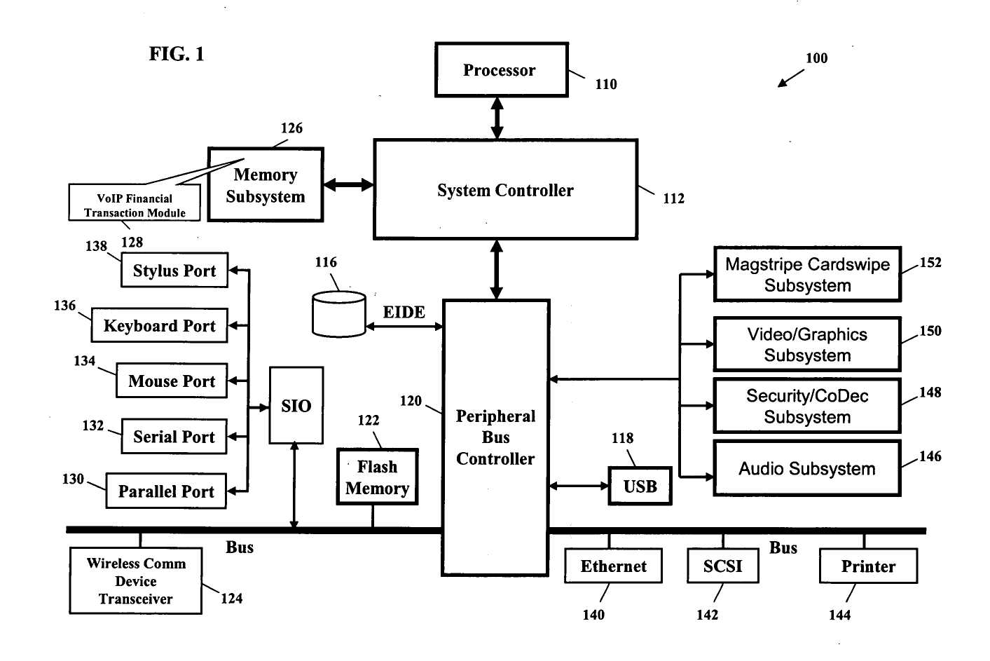

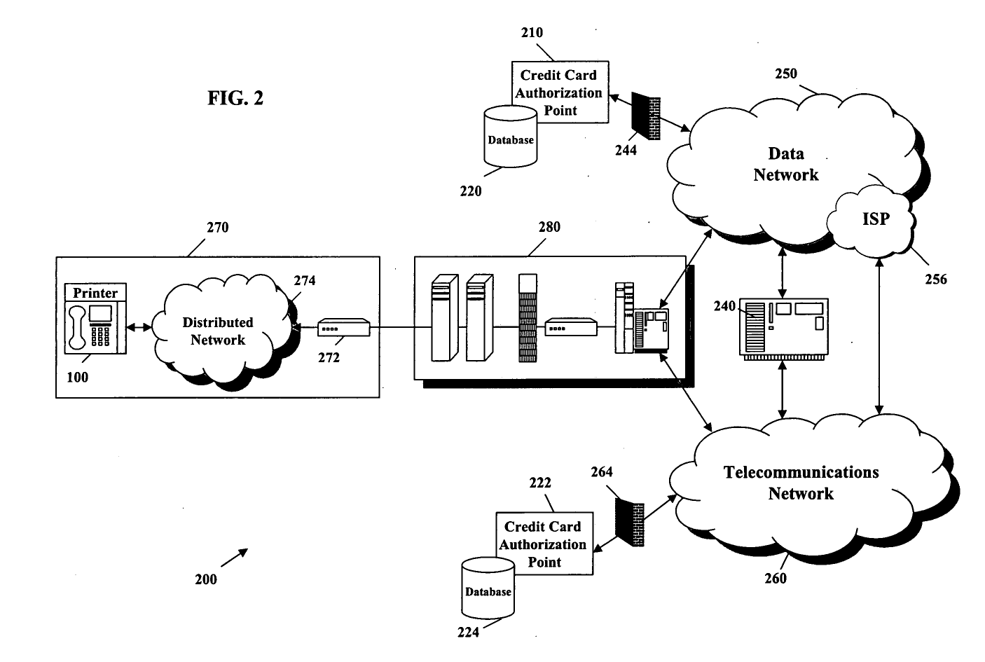

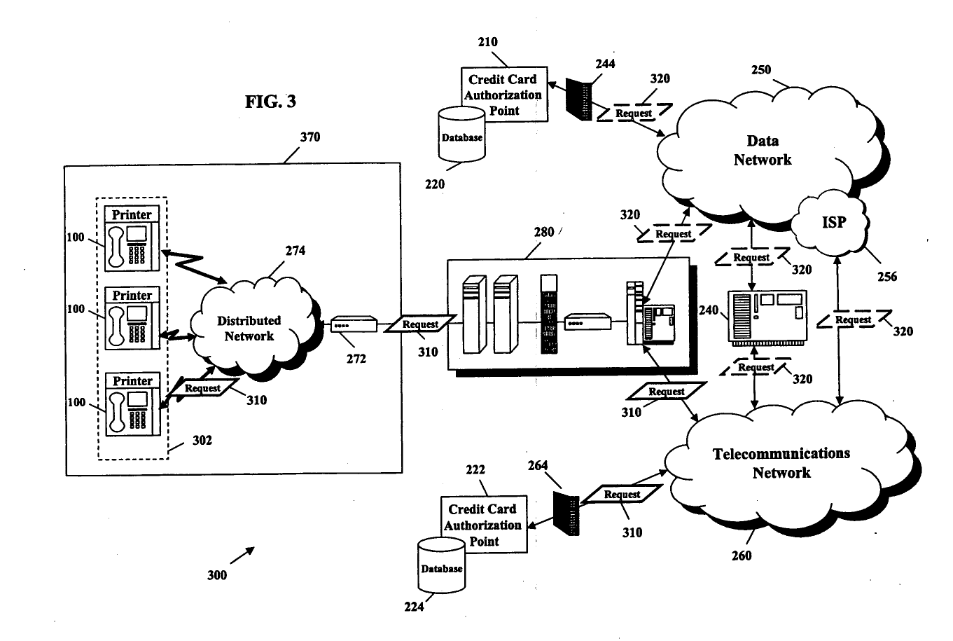

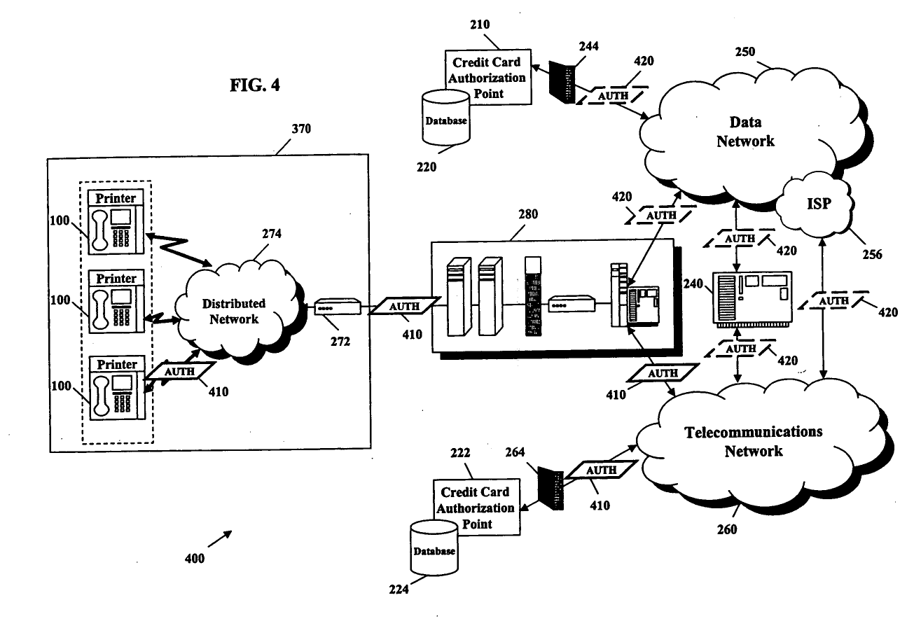

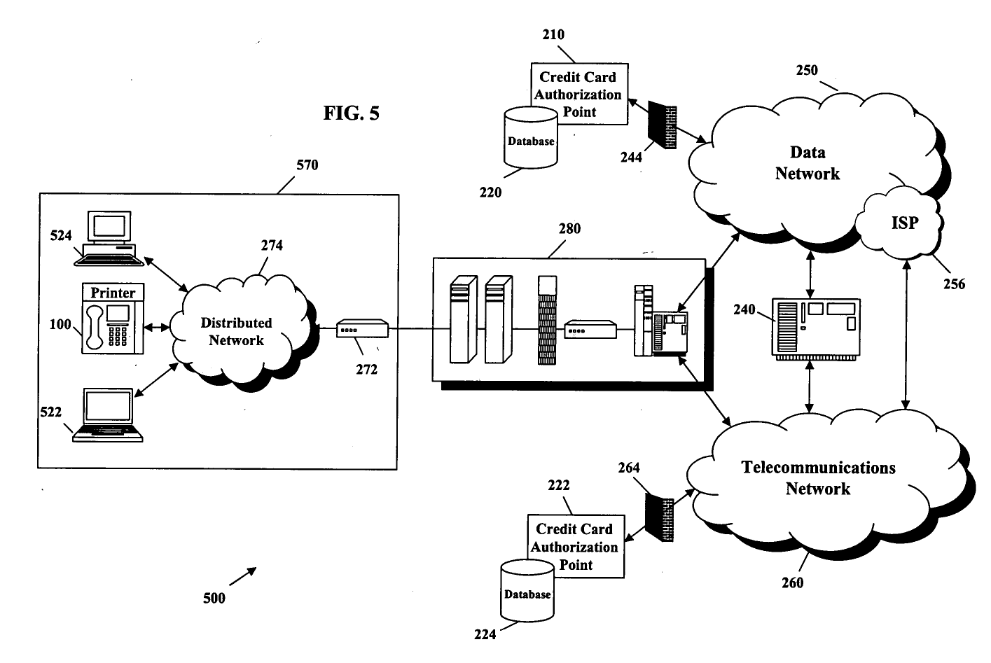

Referring now to the figures, FIG. 1 illustrates an operating system according to embodiments of this invention. FIG. 1 is a block diagram showing the VoIP Financial Transaction Module 128 residing in a computer system shown as a voice/data financial transaction communications device 100. As FIG. 1 shows, the VoIP Financial Transaction Module 128 operates within a system memory device. The VoIP Financial Transaction Module 128, for example, is shown residing in a memory subsystem 126. The VoIP Financial Transaction Module 128, however, could also reside in flash memory 122 or a peripheral storage device 116. The voice/data financial transaction communications device 100 also has one or more central processors 110 executing an operating system. The operating system, as is well known in the art, has a set of instructions that control the internal functions of the voice/data financial transaction communications device 100, and furthermore has the capability to communicate a communications signal (such as a financial transaction request shown as reference numeral 215 in FIGS. 2 and 4 and/or an authorization response shown as reference numeral 315 in FIGS. 3 and 5) between the voice/data financial transaction communications device 100 and an authorization financial institution communications address (shown as reference numerals 210 and 222 in FIGS. 2-5) and/or an alternate communications address (e.g., an incoming/outgoing phone call, an incoming/outgoing email, and so on).

The system controller 112 (typically called the “Northbridge”) provides a bridging function between the one or more central processors 110, a memory subsystem 126, and the peripheral bus controller 120. The peripheral bus controller 120 (typically called a “Southbridge”) controls the PCI (Peripheral Controller Interface) bus 160 and is an integrated circuit that serves as an input/output hub for a video/graphics subsystem 150, a magstripe card swipe subsystem 152, a security/CoDec subsystem 148, an audio subsystem 146, and for various peripheral ports and/or transceivers. These peripheral ports allow the voice/data financial transaction communications device 100 to communicate with a variety of devices and/or a communications network through networking ports, such as SCSI 142 or Ethernet 140, and/or transceivers that include wireless communications (“comm”) device transceiver 124 (for wireless communications of any frequency signal in the electromagnetic spectrum, for example, wireless 802.11 and infrared). These peripheral ports could also include other networking ports, such as a serial port 132, a parallel port 130, a mouse port 134, a keyboard port 136, and/or a stylus port 138. The PCI 160 links a printer 144 to the voice/data financial transaction communications device 100 for printing receipts for financial transactions of the device 100.

Those of ordinary skill in the art also understand the central processor 110 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described in this patent are not limited to any particular central processor of a manufacturer.

The operating system may be a UNIX® operating system (UNIX® is a registered trademark of the Open Source Group, www.opensource.org). Other UNIX-based operating systems, however, are also suitable, such as LINUX® or a RED HAT® LINUX-based system (LINUX® is a registered trademark of Linus Torvalds, and RED HAT® is a registered trademark of Red Hat, Inc., Research Triangle Park, N.C. Carolina, 1-888-733-4281, www.redhat.com). Other operating systems, however, are also suitable. Such other operating systems would include a WINDOWS-based operating system (WINDOWS® is a registered trademark of Microsoft Corporation, One Microsoft Way, Redmond Wash. 98052-6399, 425.882.8080, www.Microsoft.com) and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

The system memory device (shown as memory subsystem 126 and/or peripheral storage device 116) may also contain an application program. The application program cooperates with the operating system and with a display unit to provide a graphical user interface (GUI). The graphical user interface typically allows a user to input a combination of signals (such as signals communicated from the audio subsystem 146, the video/graphics subsystem 150, the magstripe card swipe subsystem, and/or signals from one or more of the peripheral ports, such as the keyboard port 136, and/or alternative input devices). The graphical user interface provides a convenient visual and/or audible interface with the voice/data financial transaction communications device 100.

As shown in FIG. 2, a voice/data financial transaction communications operating environment 200 includes a customer premise network 270 including the voice/data financial transactions communications device 100, a distributed network 274, and a customer gateway 272, a call control and service logic system 280, a data communications network 250 communicating over a firewall 244 with a credit card authorization point 210 that includes a database 220, an Internet Service Provider (ISP) 256, a Voice XML Gateway 240, and a telecommunications network 260 communicating over another firewall 264 with another credit card authorization point 222 that includes another database 224. FIG. 2 illustrates the customer premise network 270 with a wired connection to the call control and service logic system 280 via a distributed network 274 and customer gateway 272, however as known in the art, the communications connection may be wireless as shown in some of the below embodiments, such as embodiments depicted in FIGS. 3 and 4. The distributed network 274 may be a local area network, a wide area network, and/or other networking architects as known in the art. According to embodiments of this invention, the voice/data financial transaction communications device 100 communicates with the data network 250 and/or the telecommunications network 260 via the call control and service logic system 280. The customer gateway 272 communicates with a gateway of the call control and service logic system 280 to connect the customer premise network 270 and the call control and service logic system 280. The customer gateway 272, gateway of the call control and service logic system 280, and other gateways will not be further explained as their functions are known in the art. The call control and service logic system 280 acts as a “middleman” that enables communications between the voice/data financial transaction communications device 100 and the credit card authorization point 210 of the data communications network 250 and/or the credit card authorization point 222 of the telecommunications network 260. According to embodiments of this invention, the call control and service logic system 280 communicates with the data communications network 250 and/or the telecommunications network 260 via an integrated communications switch of the call control and service logic system 280. This communications switch of the call control and service logic system 280 may include a packet-based “softswitch” that uses software control to provide voice, data, and video services by dynamically changing its connection data rates and protocol types. In this case an application server interfaces with the switch via a packet protocol, such as Session Initiation Protocol (SIP) or H.323. In addition, the communication switch of the call control and service logic system 280 may include Advanced Intelligent Network (AIN) componetry controlling many features of the communications with the telecommunications network 260. The communications signaling, connections, and/or logic amongst the call control and service logic system 280, the data network 250, the Voice XML gateway 240, the ISP 256, and/or the telecommunications network 260, however, are well understood in the art and will not be further described.

FIG. 3 illustrates a voice/data financial transaction communications operating environment 300 similar to the voice/data financial transaction communications operating environment 200 of FIG. 2; however, operating environment 300 includes multiple voice/data financial transaction communication devices 100 of a merchant network 302 (e.g., multiple check-out terminals at a grocery store) with one of the multiple devices 100 wirelessly communicating a financial transaction request 310 (also referred to herein as the “request”) to the call control and service logic system 280 for communicating the request 310 to a financial institution authorization communications address. According to some of the embodiments of this invention, the VoIP financial transaction communications module (shown in FIG. 1 as reference numeral 128) operates within the voice/data financial transaction communications device 100 to detect and capture data of a financial card medium (e.g., debit, credit card, gift card, and others). Typically, the financial card data is captured by “swiping” a magnetic strip of the card medium via the magstripe cardreader subsystem (shown as reference numeral 152 of FIG. 1). Alternatively, the financial card data may be entered in another digital and/or analog form. For example, a user may manually enter financial card data. The financial card data includes a financial institution authorization communications address (e.g., the communications address(es) of the credit card authorization point 210 and/or 222), a card identifier (e.g., debit, credit card, gift card, and others), an expiration date, a cardholder identifier (e.g., name of cardholder account, billing address, and so on), and/or a monetary limit for the financial card. The VoIP financial transaction communications module uses the financial card data and other transactional data to create a financial transaction request 310. The transactional data may include a monetary amount of the financial transaction (e.g., for goods and/or services), an identifier of the goods and/or services, a merchant identifier, and/or a financial institution and financial institution information of the merchant.

The operating system 300 controls communication signals, such as the financial transaction request 310, with the call control and service logic system 280 for further communications with the data communications network 250 and/or the telecommunications network 260. The communication signal may include a data communications signal, a voice communications signal, and/or a visual communications signal. The financial transaction request 310 is communicated from the voice/data financial transaction communications device 100 to the call control and service logic system 280, and the call control and service logic system 280 detects and decodes a communications address of the financial institution to identify the communications address as a data communications address for the credit card authorization point 210 and/or as a telecommunications address for the credit card authorization point 222. According to some of the embodiments, if the communications address is a telecommunications communications address, then the call control and service logic system 280 communicates the request 310 to the destination credit card authorization point 222 via the telecommunications network 260. According to alternate embodiments, if the communications address is identified as a data communications address, then the call control and service logic system 280 may communicate the request 310 to the destination credit card authorization point 210 via the data network 260. Still further, the financial request 310 may be communicated via ISP 256 and/or Voice XML Gateway 240 between the data network 250 and the telecommunications network 260. For example, if the communications address is a telecommunications address and there is a communications failure (to the telecommunications address), then the financial card data may include an alternate financial institution authorization communications address (e.g., an alternate data communications address to the credit card authorization point 210) that could be communicated with the request 310 so that the call control and service logic system 280 routes the request 310 to the data communications network 250 for connection with the alternate credit card authorization point 210 of the data communications network 250 when there is a telecommunications failure.

FIG. 4 illustrates a financial transaction communications operating environment 400 similar to the financial transaction communications operating environment 300 of FIG. 3. However, operating environment 400 illustrates the response communication of a financial transaction authorization 410 (also referred to herein as the “authorization”) from the credit card authorization point 210 of the data network 250 and/or the credit card authorization point 222 of the telecommunications network 260 to the originating voice/data financial transaction communications device 100 of merchant network 302. After the credit card authorization point 222 and/or 210 receives the financial transaction request (shown in FIG. 3 as reference numeral 310), the financial institution accesses a database (such as database 220 and/or 224), processes the request 310, and then communicates the authorization 410 (or alternate message, such as a rejection or communications failure) to the originating voice/data financial transaction communications device 100 via the telecommunications network 260 and/or the data communications network 260, the call control and service logic system 280, and distributed network 270 including the merchant network 302. When the VoIP financial transaction communications module (shown as reference numeral 128 of FIG. 1) receives the authorization 410, the VoIP financial transaction communications module, working with the originating voice/data financial transaction communications device 100, processes, presents, and/or otherwise completes the financial transaction. According to further embodiments, the VoIP financial transaction communications module may communicate with a printer of the voice/data financial transaction communications device 100 to print out a receipt of the transaction and/or an alternate transactional document (e.g., an email, a text message, and so on).

FIG. 5 illustrates a voice/data financial transaction operating environment 500 similar the voice/data financial transaction operating environments 300 and 400 of FIGS. 3 and 4; however, operating environment 500 includes a different customer premise network 570 having the voice/data financial transaction communications device 100 along with different communications devices shown as a personal computer 524 and a laptop computer 522. The personal computer 524 and the laptop computer 522 include the VoIP financial transaction communications module 128 of FIG. 1 and carry out financial transactions similar to the financial transactions described for the voice/data financial transaction communications device 100 in FIGS. 3 and 4.

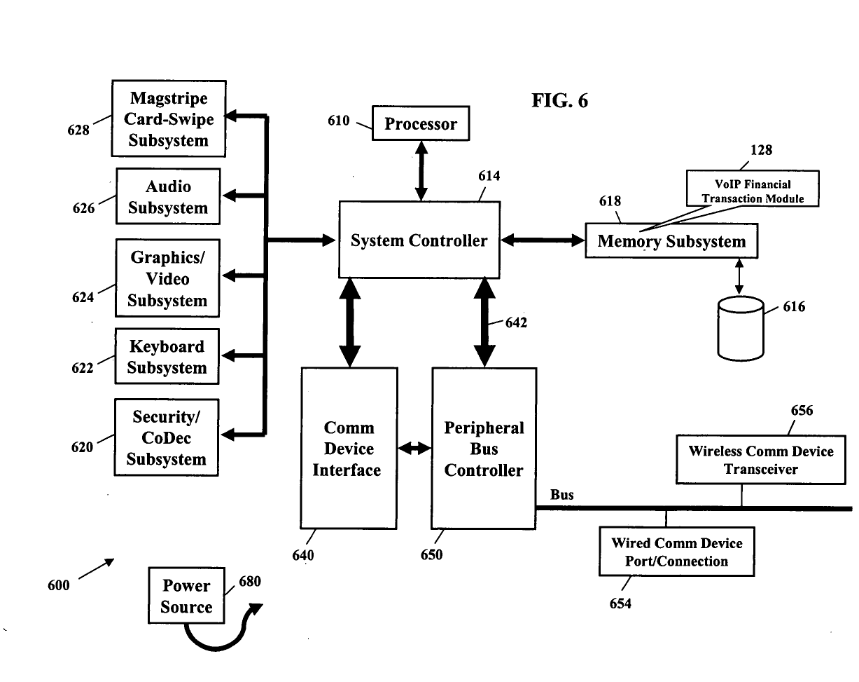

FIG. 6 depicts another block diagram of the VoIP Financial Transaction Module 128 residing in an alternate computer system shown as voice/data financial transactions communications device 600. As FIG. 6 shows, the VoIP Financial Transaction Module 128 operates within a system memory device. The VoIP Financial Transaction Module 128, for example, is shown residing in a memory subsystem 618. The VoIP Financial Transaction Module 128, however, could also reside in a peripheral storage device 616. The voice/data financial transaction communications device 600 also has one or more central processors 610 executing an operating system. The operating system, as is well known in the art, has a set of instructions that control the internal functions of the voice/data financial transaction communications device 600. A communications interface 640 communicates signals, such as a financial transaction request (shown in as reference numeral 310 in FIG. 3), an authorization (shown as reference numeral 410 of FIG. 4), data signals, control signals, and/or address signals, between the central processor 610 and a system controller 614 (typically called a “Northbridge”). Additionally, the communications interface 610 has a means to communicate the communications signal between the voice/data financial transaction communications device 600 and a communications network (such as a data network shown as reference number 250 in FIGS. 2-5 and a telecommunications network shown as reference number 260 in FIGS. 2-5).

The system controller 614 provides a bridging function between the one or more central processors 610, a video/graphics subsystem 624, a keyboard subsystem 622, an audio subsystem 626, a magstripe card swipe subsystem 628, a security/CoDec subsystem 620, the memory subsystem 618, a PCI (Peripheral Controller Interface) bus 650, and a Communications (“Comm”) Device Interface 640. The PCI bus 642 is controlled by a Peripheral Bus Controller 650. The Peripheral Bus Controller 650 (typically called a “Southbridge”) is an integrated circuit that serves as an input/output hub for various peripheral ports and/or transceivers. The peripheral bus controller 650 allows for communications with a communications network. The peripheral ports allow the voice/data financial transaction communications device 600 to communicate with a variety of devices through networking ports (such as SCSI or Ethernet, not shown) and/or transceivers that include Wireless Communications (“Comm”) Device Transceiver 656 (for communication of any frequency signal in the electromagnetic spectrum, such as, for example, Wireless 802.11 and Infrared) and Wired Communications (“Comm”) Device Port/Connection 654 (such as modem V90+ and compact flash slots). These peripheral ports could also include other networking ports, such as, a serial port (not shown) and/or a parallel port (not shown). In another embodiment, the voice/data financial transaction communications device 600 may include a power source 680, such as a rechargeable battery to provide power and allow the voice/data financial transaction communications device 600 to be portable. Additionally, those of ordinary skill in the art understand that the program, processes, methods, and systems described in this patent are not limited to any particular computer system or computer hardware.

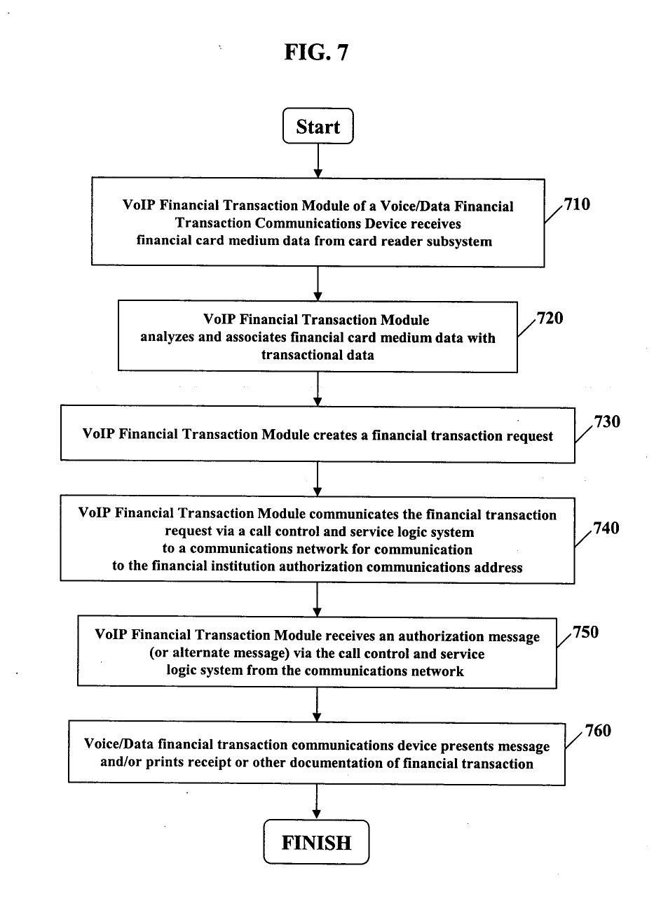

FIG. 7 illustrates a flowchart of a method for providing financial transaction communications according to some of the exemplary embodiments of this invention. A voice/data financial transaction communications device equipped with a VoIP Financial Transaction Module, a credit card processing terminal, and a VoIP phone receives a financial card medium financial data from a card reader subsystem of the credit card processing terminal [block 710]. The voice/data financial transaction communications module analyzes and associates the financial card medium data with transactional data [block 720] to create and/or otherwise prepare a financial transaction request [block 730]. Thereafter, the voice/data financial transaction communications device communicates the financial transaction request to a call control and service logic system for communication to a financial institution authorization communications address via a data and/or telecommunications network [block 740]. In response, the financial institution authorization communications address communicates an authorization message to approve, deny, and/or otherwise respond to the request, and this response is communicated via the data and/or telecommunications network to the call control and service logic system and then to the VoIP Financial Transaction Module of the voice/data financial transaction communications device [block 750]. Then, the voice/data financial transaction communications device presents the response message and/or prints a receipt or alternate documentation (e.g., email conformation number, text message, and so on) for the financial transaction [block 760].

The VoIP Financial Transaction Module (shown as reference numeral 128 in FIGS. 1 and 6) may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah. 84067, 801.332.1000, www.iomega.com). This computer-readable medium, or media, could be distributed to end-users, licensees, and assignees. These types of computer-readable media and other types not mention here but considered within the scope of the present invention, allow the VoIP Financial Transaction Module to be easily disseminated.

The VoIP Financial Transaction Module may be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol phone, or a wireless pager.

While this invention has been described with respect to various features, aspects, and embodiments, those skilled and unskilled in the art will recognize this invention is not so limited. Other variations, modifications, and alternative embodiments may be made without departing from the spirit and scope of this invention.

What is claimed is:

1. A voice/data financial transaction communications system, comprising:
a voice over internet protocol communications device having a card reader subsystem for reading a financial card medium, a Voice-over Internet Protocol Financial Transactions Module stored in a memory device, a processor communicating with the memory device, and a communications interface to a call control and service logic system for communicating with a communications network,
the Voice-over Internet Protocol Module,
receiving data of the financial card medium from the card reader subsystem, the financial medium data identifying at least one of a financial institution authorization communications address, a card identifier, an expiration date, a monetary limit for a financial transaction, and a cardholder identifier,
communicating a financial transaction request to the financial institution authorization communications address, the request comprising the financial medium data, merchant data, and a monetary amount, the merchant data identifying at least one of a merchant communications address, a merchant identifier, a financial institution of the merchant, and a merchandise identifier, and
receiving an authorization from the financial institution authorization communications address for the requested monetary amount.

2. The voice/data financial transaction communications system according to claim 1, wherein the voice-over internet protocol communications device further comprises a communications device of a distributed network.

3. The voice/data financial transaction communications system according to claim 2, wherein the call control and service logic system comprises an Internet Protocol Centrex system.

4. The voice/data financial transaction communications system of claim 1, wherein the voice-over internet protocol communications device further comprises:
a keyboard subsystem for communicating data with the voice-over internet protocol communications device.

5. The voice/data financial transaction communications device of claim 4, wherein the keyboard subsystem comprises at least one of the following:
a keyboard;
a mouse; and
a stylus.

6. The voice/data financial transaction communications system of claim 1, wherein the voice-over internet protocol communications device further comprises:
a display for communicating visual data with the voice-over internet protocol communications device.

7. The voice/data financial transaction communications system of claim 1, wherein the voice-over internet protocol communications device further comprises:
an audio subsystem for communicating audio data with the voice-over internet protocol communications device.

8. The voice/data financial transaction communications system of claim 1, wherein the voice-over internet protocol communications device further comprises:
a power source for the voice-over internet protocol communications device.

9. The voice/data financial transaction communications system of claim 8, wherein the power source is a battery power source.

10. The voice/data financial transaction communications system of claim 1, wherein the voice-over internet protocol communications device further comprises:
a peripheral bus controller operating to control a communications signal with the communications interface to the call control and service logic system, the communications signals comprising at least one of the request, the authorization, and a voice communications signal, the voice communications signal connecting the voice-over internet protocol communications device and another communications device of another communications address.

11. The voice/data financial transaction communications system of claim 10, wherein the call control and service logic system comprises a voice and data switch, the voice and data switch establishing a communications connection with at least one of a telecommunications network and a data network.

12. The voice/data financial transaction communications system of claim 1, wherein the voice-over internet protocol communications device further comprises:
a printer for printing out a receipt of the financial transaction.

13. A voice/data financial transaction communications system, comprising:
at least one input/output processor to access, input, and output at least one of data of a financial card medium, a financial transaction request, and an authorization for the financial transaction request;
a memory device for storing a Voice over Internet Protocol Financial Transaction Module; and
a processor communicating with the memory device, the processor operating with Voice over Internet Protocol Financial Transaction Module for processing at least one of the financial card medium, the request, and the authorizations; and
a call control and service logic system, the call control and service logic system comprising means for communicating with a financial institution authorization communications address.

14. The voice/data financial transaction communications system of claim 13, further comprising at least one of:
a graphics/video subsystem;
a keyboard subsystem;
an audio subsystem;
a magstripe cardswipe subsystem; and
a security codec subsystem.

15. The voice/data financial transaction communications system of claim 14, further comprising:
at least one of a wireless communications transceiver and a wired communications port for communicating a communications signal via the call control and service logic system to at least one of a communications network and another communications device.

16. A computer program product, comprising:
a computer-readable medium; and
a Voice over Internet Protocol Financial Transaction Module stored on the computer-readable medium, the Voice over Internet Protocol Financial Transaction Module,
receiving data of the financial card medium from a card reader subsystem, the financial medium data identifying at least one of a financial institution authorization communications address, a card identifier, an expiration date, a monetary limit for a financial transaction, and a cardholder identifier,
communicating a financial transaction request to the financial institution authorization communications address, the request comprising the financial medium data, merchant data, and a monetary amount, the merchant data identifying at least one of a merchant communications address, a merchant identifier, a financial institution of the merchant, and a merchandise identifier, and
receiving an authorization from the financial institution authorization communications address for the requested monetary amount.

18. The computer program product of claim 17, wherein the computer-readable medium is stored to a voice-over internet protocol communications device.

19. The computer program product of claim 17, wherein the computer-readable medium is stored to a computer system.
